(19) United States
(12) Patent Application Publication
(10) Pub. No.: US 2016/0237294 A1
(43) Pub. Date: Aug. 18, 2016

(54) LOW-FOAMING INK COMPOSITIONS INCLUDING FLUOROSURFACTANTS FOR INDIRECT PRINTING

(71) Applicant: XEROX CORPORATION, Norwalk, CT (US)

(72) Inventors: Valerie M. Farrugia, Oakville (CA); Guiqin Song, Milton (CA); Jenny Eliyahu, Maple (CA)

(73) Assignee: XEROX CORPORATION

(21) Appl. No.: 15/143,099

(22) Filed: Apr. 29, 2016

Related U.S. Application Data
(63) Continuation of application No. 14/516,413, filed on Oct. 16, 2014.

(51) Int. Cl. C09D 11/38; C09D 11/328; C09D 11/108; C09D 11/322

(52) U.S. Cl. CPC C09D 11/38; C09D 11/322; C09D 11/328; C09D 11/108

(57) ABSTRACT

The present disclosure provides an ink comprising a fluorosurfactant-stabilized polymer latex, which is suitable for use in an indirect printing method.

### CROSS-REFERENCE TO RELATED APPLICATION

This application is a continuation of U.S. application Ser. No. 14/516,413 filed Oct. 16, 2014, which is expressly incorporated herein by reference in its entirety.

### INTRODUCTION

The presently disclosed embodiments are related generally to low-foaming ink compositions comprised of fluorosurfactant-stabilized latex for indirect printing method.

Indirect printing process is a two-step printing process wherein the ink is first applied imagewise onto an intermediate receiving member (drum, belt, etc.) using an inkjet printhead. The ink wets and spreads onto the intermediate receiving member to form a transient image. The transient image then undergoes a change in properties (e.g., partial or complete drying, thermal or photo-curing, gelation etc.) and the resulting transient image is then transferred to the substrate.

Inks suitable for such indirect printing process must be designed and optimized to be compatible with the different subsystems, such as, jetting, transfer, etc., that enable high quality printing at high speed. Typically, inks that display good wettability do not transfer onto a substrate, or conversely inks that transfer efficiently to the substrate do not wet the intermediate receiving member. To date, there is no commercially available ink that enables both the wetting and the transfer functions. Inks that display good wettability typically do not transfer onto a substrate, or conversely do not wet the intermediate receiving member but transfer efficiently to the substrate.

Latexes employed for use in indirect printing are required to meet various properties, including specific thermal characteristics and mechanical stability, excellent film-forming, adequate drying speed, print durability in terms of transfer and image robustness, viscosity reliability under high shear conditions, etc. The emulsion polymerized (EP) vinyl and non-vinyl based latexes have proven to be advantageous for inkjet inks, but suffer from foam formation that carries through to ink compositions. Such foaming problem prevents EP latexes from being suitable for use in inkjet printing.

To inhibit foam formation, it is necessary to include defoamers and wetting agents in the ink formulations, and therefore, the commercial ink formulations to-date all contains some types of defoamers and/or wetting agents.

Consequently, there exists a need to develop a low-forming ink suitable for indirect printing process, and particularly, there exists a need to develop an ink that exhibits good wetting of the intermediate receiving member and is capable of efficient transfer to the final substrate.

Each of the foregoing U.S. patents and patent publications are incorporated by reference herein. Further, the appropriate components and process aspects of the each of the foregoing U.S. patents and patent publications may be selected for the present disclosure in embodiments thereof.

### SUMMARY

According to embodiments illustrated herein, there is provided an ink for use in an indirect printing process comprising water; a co-solvent; and a fluorosurfactant-stabilized polymer latex.

In certain embodiments, there is provided a low-foaming ink for use in an indirect printing process comprising water; a co-solvent; and a fluorosurfactant-stabilized polymer latex, and the fluorosurfactant is an anionic phosphate ester type, and further wherein the ink has a surface tension of from about 18 to about 35 mN/m at the jetting temperature.

### BRIEF DESCRIPTION OF THE DRAWINGS

For a better understanding of the present embodiments, reference may be made to the accompanying FIGURES.

FIG. 1 is a diagrammatical illustration of an imaging member in accordance with the present embodiments for applying a two-step transfer and curing process in an indirect printing system.

### DETAILED DESCRIPTION

In the following description, it is understood that other embodiments may be utilized and structural and operational changes may be made without departure from the scope of the present embodiments disclosed herein.

In this specification and the claims that follow, singular forms such as “a,” “an,” and “the” include plural forms unless the content clearly dictates otherwise. All ranges disclosed herein include, unless specifically indicated, all endpoints and intermediate values. In addition, reference may be made to a number of terms that shall be defined as follows:

As used herein, the term “low-foaming” means that the ink composition to which said term exhibits a high shear foam height of less than 1.5 centimeter when tested at 55° C. using a single speed Waring Blender equipped with a jacketed cylindrical container.

As used herein, the term “viscosity” refers to a complex viscosity, which is the typical measurement provided by a mechanical rheometer that is capable of subjecting a sample to a steady shear strain or a small amplitude sinusoidal deformation. In this type of instrument, the shear strain is applied by the operator to the motor and the sample deformation (torque) is measured by the transducer. Examples of such instruments are the Rheometrics Fluid Rheometer RFS3 or the ARES rheometer, both made by Rheometrics, a division of TA Instruments. The invention discloses a curable aqueous latex ink which is suitable for an indirect print process, or indirect printing ink jet applications.

The present disclosure provides a low-forming latex ink, where the ink comprises a latex, and wherein the latex comprises a fluorinated surfactant (also refers to as a fluorosurfactant). The ink is suitable for use in indirect printing methods.

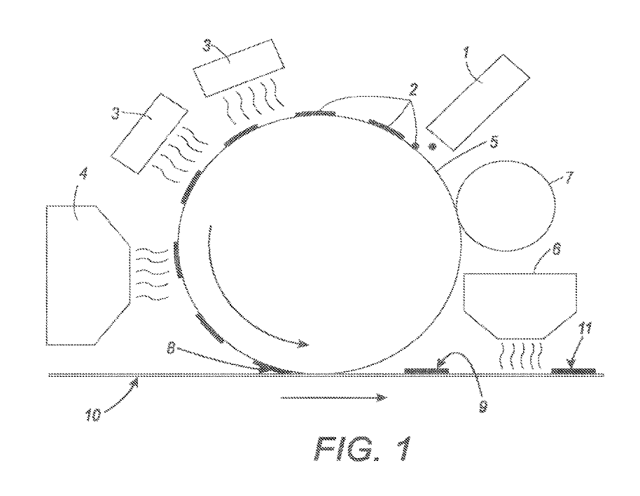

FIG. 1 discloses a diagrammatical illustration of an imaging system in accordance with the present embodiments for applying a two-step transfer and curing process whereby an ink of the present disclosure is printed onto an intermediate transfer surface for subsequent transfer to a receiving substrate. During the indirect print process, the ink of the present embodiments is jetted and spread onto an intermediate receiving member 5 via an inkjet printhead 1. The intermediate receiving member 5 may be provided in the form of a drum, as shown in FIG. 1, but may also be provided as a web, platen, belt, band or any other suitable design.

Referring again to FIG. 1, the intermediate receiving member 5 may be heated by a heater device 3 to remove the water content (partially or fully) in the ink vehicle of ink 2, and induce film formation by the residual ink which includes polymer and curable materials (e.g., monomers/oligomers). The residual ink is optionally partially cured (pre-cured) by UV radiation source 4 to reduce film splitting prior to the transfer of the ink image 8. The ink image 8 is then transferred from the intermediate receiving member 5 to the final receiving substrate 10. The transfer of the ink image may be performed through contact under pressure, and/or near the softening point of the polymer. The transferred image 9 is then further subjected to UV irradiation 6 to induce complete crosslinking thereby resulting in a robust image 11. Image robustness is especially important for packaging applications such as folding carton, for example.

It is important to note that an ink suitable for an indirect printing process must be able to wet the intermediate receiving member 5 to enable formation of the transient image 2, and undergo a stimulus-induced property change to enable release from the intermediate receiving member 5 in the transfer step.

In embodiments, the inks of the present disclosure contain water. Typical water-based inks (or aqueous inks) have the disadvantage of increased surface tension which makes the wetting of substrates more difficult especially in paper and plastic packaging. Surfactants help solving this problem by lowering the surface tension of inks to make wetting easier, unfortunately surfactants also produce foam. Surprisingly, the low-foaming inks of the present disclosure do not cause foaming issues as seen in typically water-based inks and exhibit the required low surface tension (e.g., <50 mN/m), such as from about 15 dynes/cm to about 50 mN/m, for example from about 18 mN/m to about 40 mN/m, or from about 20 mN/m to about 30 mN/m at the jetting temperature.

The ink of the present embodiments also possess the required viscosity (in the range of 3-20 cps), and particle size (<600 nm) for use in an inkjet (e.g., piezoelectric) printhead.

In embodiments, the ink has a viscosity of from about 2 cps to about 20 cps, for example from about 3 cps to about 15 cps, or from about 4 cps to about 12 cps, at the jetting temperature. In particular embodiments, the ink compositions are jetted at temperatures of less than about 70° C., such as from about 25° C. to about 70° C., or from about 30° C. to about 50° C., such as from about 30° C. to about 40° C.

In embodiments, the latex ink has an average pigment particle size of less than about 600 nm, for example from about 25 nm to about 500 nm, or from about 50 nm to about 300 nm.

The ink of the present disclosure can be prepared by adding a fluorosurfactant during the emulsion polymerization process of synthesizing the polymer latex, which aids in stabilizing the polymer latex. The resulting polymer latex is herein referred to as the fluorosurfactant-stabilized polymer latex. By incorporating a fluorosurfactant into the polymer latex, the added fluorosurfactant may help to reduce the surface tension and minimize foaming of both the latex and the ink thereof, and further may help to improve the leveling and the wetting ability of the ink. The fluorosurfactant-stabilized polymer latex of the present embodiments serves as a binder in the ink where the fluorosurfactant may help achieve certain properties in the ink.

In embodiments, the ink of the present disclosures only require a small amount of defoamer and/or a wetting agent, for example, from about 0.01% to about 2%, from about 0.05% to about 1.5%, and from about 0.05% to about 0.1% by weight based on the total weight of the ink. In embodiments, the ink of the present disclosures does not require the present of a defoamer and/or a wetting agent.

The fluorosurfactant does not covalently bind to the polymer latex. In embodiments, the fluorosurfactant may be of a phosphate ester type. In further embodiment, the fluorosurfactant may be of an ammonia neutralized phosphate ester type, or of a diethanolamine neutralized phosphate ester type. In one embodiment, the fluorosurfactant contains a perfluoro telomer based on alkyl sodium sulfonate. For example, such perfluoro telomer based on alkyl sodium sulfonate may contain a formula CF₃—(CF₂)ₙ—SO₃—, wherein n is from about 1 to 11, from about 1 to about 8, or from about 3 to about 8. In embodiments, the fluorosurfactant is soluble in water. In embodiments, the fluorosurfactant is non-telogenic. In embodiments, the fluorosurfactant is anionic. In embodiments, the fluorosurfactant comprises an anionic hydrophilic group and a hydrophobic portion.

In embodiments, the fluorosurfactant contains a partially or fully fluorinated alkyl group having from 1 to 12, or from 2 to 10, or from 2 to 8 carbon atoms. In embodiments, the fluorosurfactant contains a perfluoro telomere. In specific embodiments, the fluorosurfactant contains a C-6 perfluoro telomere.

These fluorosurfactants may be used as a polymerization aid for dispersing and, because they do not chain transfer, they do not cause formation of polymer with undesirable short chain length. An extensive list of suitable fluorosurfactants is disclosed in U.S. Pat. No. 2,559,752, which is incorporated herein by reference in its entirety. Suitable fluorosurfactants are ammonium perfluorocarboxylates, e.g., ammonium perfluorocaprylate or ammonium perfluorooctanoate.

In one embodiment, the fluorosurfactant include Chemguard S-764P which is a VOC-free, water-based, short-chain anionic fluorosurfactant of the phosphate ester type composed of short chain C-6 perfluoro telomere. It provides surface tensions as low as 17 mN/m in water at very low concentrations. It also has excellent dynamic surface tension properties, allowing for rapid attainment of low-equilibrium surface tensions, as well as, excellent thermostability at concentrations as low as 50-1,000 parts per million (0.005-0.100%). Due to their low surface tension these surfactants are also considered to be very low foaming and compared to our standard anionic surfactants like Dowfax 2A1 and Taycapower.

The fluorosurfactant may be present in the ink in an amount from about 0.0001 percent to about 0.1 percent, from about 0.001 percent to about 0.075 percent, or from about 0.0375 percent to about 0.05 percent by weight, based on the total weight of the ink.

Surfactants

The inks of the present embodiments may or may not require a second surfactant to adjust the ink properties.

In one embodiment, the inks only include one surfactant namely a fluorosurfactant described herein.

In other embodiments, the inks may further include an additional surfactant (or a second surfactant). Examples of suitable additional surfactants include ionic surfactants, anionic surfactants, cationic surfactants, nonionic surfactants, zwitterionic surfactants, and the like, as well as mixtures thereof. Examples of suitable surfactants include alkyl polyethylene oxides, alkyl phenyl polyethylene oxides, polyethylene oxide block copolymers, acetylenic polyethylene oxides, polyethylene oxide (di)esters, polyethylene oxide amines, protonated polyethylene oxide amines, protonated polyethylene oxide amides, dimethicone copolyols, substituted amine oxides, and the like, with specific examples including primary, secondary, and tertiary amine salt compounds such as hydrochloric acid salts, acetic acid salts of laurylamine, coconut amine, stearylamine, rosin amine; quaternary ammonium salt type compounds such as lauryltrimethylammonium chloride, cetyltrimethylammonium chloride, benzyltributylammonium chloride, benzalkonium chloride, etc.; pyridinium salty type compounds such as cetylpyridinium chloride, cetylpyridinium bromide, etc.; nonionic surfactant such as polyoxyethylene alkyl ethers, polyoxyethylene alkyl esters, acetylene alcohols, acetylene glycols; and other surfactants such as 2-heptadecenyl-hydroxyethylimidazoline, dihydroxyethylstearylamine, stearyldimethylbetaine, and lauryldihydroxyethylbetaine; fluorosurfactants; and the like, as well as mixtures thereof. Additional examples of nonionic surfactants include polyacrylic acid, methalose, methyl cellulose, ethyl cellulose, propyl cellulose, hydroxy ethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxy poly(ethyleneoxy) ethanol, available from Rhone-Poulenc as IGEPAL CA-210™ IGEPAL CA-520™, IGEPAL CA-720™, IGEPAL CO-890™, IGEPAL C0-720™, IGEPAL C0-290™, IGEPAL CA-21O™, ANTAROX 890™, and ANTAROX 897™. Other examples of suitable nonionic surfactants include a block copolymer of polyethylene oxide and polypropylene oxide, including those commercially available as SYNPERONIC™ PE/F, such as SYNPERONIC™ PE/F 108. Other examples of suitable anionic surfactants include sulfates and sulfonates, sodium dodecylsulfate (SDS), sodium dodecylbenzene sulfonate, sodium dodecylnaphthalene sulfate, dialkyl benzenealkyl sulfates and sulfonates, acids such as abietic acid available from Sigma-Aldrich, NEOGEN R™, NEOGEN SC™ available from Daiichi Kogyo Seiyaku, combinations thereof, and the like. Other examples of suitable anionic surfactants include DOWFAX™ 2A1, an alkyldiphenyloxide disulfonate from Dow Chemical Company, and/or TAYCA POWER BN2060 from Tayca Corporation (Japan), which are branched sodium dodecyl benzene sulfonates. Other examples of suitable cationic surfactants, which are usually positively charged, include alkylbenzyl dimethyl ammonium chloride, dialkyl benzenealkyl ammonium chloride, lauryl trimethyl ammonium chloride, alkylbenzyl methyl ammonium chloride, alkyl benzyl dimethyl ammonium bromide, benzalkonium chloride, cetyl pyridinium bromide, C 12, C15, C17 trimethyl ammonium bromides, halide salts of quaternized polyoxyethylalkylamines, dodecylbenzyl triethyl ammonium chloride, MIRAPOL™ and ALKAQUAT™, available from Alkaril Chemical Company, SANIZOL™ (benzalkonium chloride), available from Kao Chemicals, and the like, as well as mixtures thereof. Mixtures of any two or more surfactants can be used.

The second surfactant can be present in any desired or effective amount. In embodiments, the second surfactant is present in an amount of from about 0.01 to about 5 percent by weight, based on the total weight of the ink composition. It should be noted that the surfactants are named as dispersants in some cases.

The total surfactant (i.e., fluorosurfactant+second surfactant) may be present in the ink in an amount from about 0.0001 percent to about 5 percent, from about 0.001 percent to about 3 percent, or from about 0.03 percent to about 2 percent by weight, based on the total weight of the ink.

Water and Co-Solvent

In embodiments, the ink compositions contain at least one co-solvent having a solubility parameter in the range of from about 27 to about 37 MPa^{1/2} or from about 27 to about 35 MPa^{1/2}. In embodiments, the ink compositions contain a single co-solvent having a solubility parameter in the range of from about 27 to about 37 MPA^{1/2} or from about 27 to about 35 MPa^{1/2} or a mixture of co-solvents wherein the solubility parameter of the mixture is from about 27 to about 37 MPA^{1/2} or from about 27 to about 35 MPa^{1/2}. In embodiments, such a co-solvent is 1,5-pentanediol. In certain embodiments, the co-solvent is selected from the group consisting of 1,5-pentanediol, 2-pyrollidone, glycerol, and mixtures thereof. In specific embodiments, the co-solvent is 1,5-pentanediol and a member of the group consisting of 2-pyrollidone, glycerol, and mixtures thereof.

In embodiments, the ink compositions contain at least one co-solvent having a solubility parameter in the range of from about 27 to about 35 MPa^{1/2}. In embodiments, the co-solvent is a mixture of 1,5-pentanediol and 2-pyrollidone. In certain embodiments, the co-solvent is 1,5-pentanediol. In other embodiments, the co-solvent is 2-pyrollidone.

In certain embodiments, the co-solvent is selected from the group consisting of 1,5-pentanediol, 2-pyrollidone, glycerol, and mixtures thereof; and the individual co-solvent or mixture of co-solvents has a solubility parameter in the range of from about 27 to about 33 MPa^{1/2}.

SI Hildebrand solubility parameters are expressed in mega-pascals. Hildebrand solubility parameter is known to those of skill in the art. The Hildebrand value of a solvent mixture can be determined by averaging the Hildebrand values of the individual solvents by volume as known by those of skill in the art. For example, the target range for measuring solubility parameter is from room temperature to jetting temperature, in embodiments, from about 20 to about 40° C. Solubility parameters can be determined using modeling software such as Molecular Modeling Pro Plus available from Norgwyn Montgomery Software Inc. In embodiments, the solubility parameter for 1,5-pentanediol at 25° C. is 27.6, the solubility parameter for 2-pyrrolidone at 25° C. is 28.4, and the solubility parameter for glycerol at 25° C. is 36.5.

The inks may consist solely of water, or can comprise a mixture of water and a water soluble or water miscible organic component, referred to as a co-solvent, humectant, or the like (hereinafter co-solvent) such as alcohols and alcohol derivatives, including aliphatic alcohols, aromatic alcohols, diols, glycol ethers, polyglycol ethers, long chain alcohols, primary aliphatic alcohols, secondary aliphatic alcohols, 1,2-alcohols, 1,3-alcohols, 1,5-alcohols, ethylene glycol alkyl ethers, propylene glycol alkyl ethers, methoxylated glycerol, ethoxylated glycerol, higher homologues of polyethylene glycol alkyl ethers, and the like, with specific examples including ethylene glycol, propylene glycol, diethylene glycols, glycerine, dipropylene glycols, polyethylene glycols, polypropylene glycols, trimethylolpropane, 1,5-pentanediol, 2-methyl-1,3-propanediol, 2-ethyl-2-hydroxymethyl-1,3-propanediol, 3-methoxybutanol, 3-methyl-1,5-pentanediol, 1,3-propanediol, 1,4-butanediol, 2,4-heptanediol, and the like; also suitable are amides, ethers, urea, substituted ureas such as thiourea, ethylene urea, alkylurea, alkylthiourea, dialkylurea, and dialkylthiourea, carboxylic acids and their salts, such as 2-methylpentanoic acid, 2-ethyl-3-propylacrylic acid, 2-ethyl-hexanoic acid, 3-ethoxyproponic, acid, and the like, esters, organosulfides, organosulfoxides, sulfones (such as sulfolane), carbitol, butyl carbitol, cellusolve, ethers, tripropylene glycol monomethyl ether, ether derivatives, hydroxyethers, amino alcohols, ketones, N-methylpyrrolidinone, 2-pyrrolidinone, cyclohexylpyrrolidone, amides, sulfoxides, lactones, polyelectrolytes, methyl sulfonylethanol, imidazole, 1,3-dimethyl-2-imidazolidinone, betaine, sugars, such as 1-deoxy-D-galactitol, mannitol, inositol, and the like, substituted and unsubstituted formamides, substituted and unsubstituted acetamides, and other water soluble or water miscible materials, as well as mixtures thereof. In embodiments, the co-solvent is selected from the group consisting of ethylene glycol, N-methylpyrrolidone, methoxylated glycerol, ethoxylated glycerol, and mixtures thereof. In certain embodiments, the co-solvent is selected from the group consisting of sulfolane, methyl ethyl ketone, isopropanol, 2-pyrrolidinone, polyethylene glycol, and mixtures thereof.

When mixtures of water and water soluble or miscible organic liquids are selected as the liquid vehicle, the water to organic ratio ranges can be any suitable or desired ratio, in embodiments from about 97:3 to about 30:70, or from about 95:5 to about 40:60, or from about 90:10 to about 51:49. The non-water component of the liquid vehicle generally serves as a humectant which has a boiling point higher than that of water (100° C.), or as a co-solvent which has a boiling point as low as 70° C. The organic component of the ink vehicle can also serve to modify ink surface tension, modify ink viscosity, swell the latex and/or disperse the colorant, and/or affect the drying characteristics of the ink.

The total amount of liquid vehicle can be provided in any suitable or desired amount. In embodiments, the liquid vehicle is present in the ink composition in an amount of from about 55 to about 97 percent, or from about 60 to about 90 percent, or from about 65 to about 90 percent, by weight, based on the total weight of the ink composition.

Latexes

Latexes generally comprise a stable dispersion (or emulsion) of polymer microparticles in an aqueous medium. The ink of the present embodiments may include one or more polymer latex.

In embodiments, the ink of the present embodiments includes a polymer latex, such as a polystyrene copolymer latex. The polystylene copolymer latex comprises (or can be derived from) styrene monomer and one or more co-monomers such as alkyl acrylate, alkyl methacrylate, alkyl acrylate-acrylic acid, 1,3-diene-acrylic acid, alkyl methacrylate-acrylic acid, alkyl methacrylate-alkyl acrylate, alkyl methacrylate-aryl acrylate, aryl methacrylate-alkyl acrylate, alkyl methacrylate-acrylic acid. In certain embodiments, the co-monomer is selected from among acrylates, methacrylates and mixtures thereof. In certain embodiments, the copolymer is comprised of styrene monomer and an alkyl acrylate. In one embodiment, the copolymer is comprised of styrene monomer and butyl acrylate, e.g., n-butyl acrylate. In embodiments, the copolymer includes β-carboxyethyl acrylate (β-CEA).

In certain embodiments, the polymer latex comprises a latex emulsion comprising polymer particles generated from the emulsion polymerization of styrene, n-butyl acrylate, methacrylic acid, beta-CEA (β-carboxyethyl acrylate), and/or mixtures thereof.

In certain embodiments, the polystyrene copolymer latex includes an acrylic emulsion latex, obtained from alkyl acrylates having alkyl groups of from 1 to 18 carbon atoms, from 1 to 6 carbon atoms, or from 1 to 4 carbon atoms.

The polystyrene copolymer latex may be crosslinked. This may be done by including one or more crosslinking monomers. Crosslinking monomers may include, for example, divinylbenzene or diethylene glycol methacrylate. The crosslinking monomer(s) may be included in effective amounts, for example from about 0.01 to about 20 percent by weight of the polymer. A crosslinked resin thus refers, for example, to a crosslinked resin or gel comprising, for example, about 0.3 to about 20 percent crosslinking.

In embodiments, a weight ratio of the styrene monomer to the co-monomer is from about 1:0.1 to about 1:10, although the amount can be outside of these ranges. In further embodiments, the ratio is from about from about 1:1 to about 1:6, from about 1:1.2 to about 1:5, or from about 1:5 to about 1:3.5. In embodiments, the styrene monomer is present in an amount of from 55 to about 95 percent, or of from 65 to about 85 percent, or of from 75 to about 82 percent by weight of the total weight of the ink composition, although the amount can be outside of these ranges.

The polystyrene copolymer latex of the present embodiments may have a glass transition temperature (Tg) in the range of from about 40° C. to about 70° C., from about 50° C. to about 65° C., from about 55° C. to about 63° C.

The polystyrene copolymer latex of the present embodiments may have a weight average molecular weight (Mw) of from about 5,000 g/mol to about 40,000 g/mol, in embodiments from about 15,000 g/mol to about 30,000 g/mol, or from about 18,000 g/mol to about 25,000 g/mol.

The polystyrene copolymer latex of the present embodiments may have an average particle size of from about 50 to about 600 nm, from about 50 to about 500 nm, or from about 50 to about 300 nm.

The total amount of polystyrene copolymer latex included in the ink composition may be from, for example, about 1 percent to about 20 percent by weight, such as from about 1 percent to about 15 percent, or from about 1 percent to about 10 percent by weight of the ink composition.

The ink compositions herein can consist solely of water, or can comprise a mixture of water and a water soluble or water miscible organic component, referred to as a co-solvent, humectant, or the like (hereinafter co-solvent) such as alcohols and alcohol derivatives, including aliphatic alcohols, aromatic alcohols, diols, glycol ethers, polyglycol ethers, long chain alcohols, primary aliphatic alcohols, secondary aliphatic alcohols, 1,2-alcohols, 1,3-alcohols, 1,5-alcohols, ethylene glycol alkyl ethers, propylene glycol alkyl ethers, methoxylated glycerol, ethoxylated glycerol, higher homologues of polyethylene glycol alkyl ethers, and the like, with specific examples including ethylene glycol, propylene glycol, diethylene glycols, glycerine, dipropylene glycols, polyethylene glycols, polypropylene glycols, trimethylolpropane, 1,5-pentanediol, 2-methyl-1,3-propanediol, 2-ethyl-2-hydroxymethyl-1,3-propanediol, 3-methoxybutanol, 3-methyl-1,5-pentanediol, 1,3-propanediol, 1,4-butanediol, 2,4-heptanediol, and the like; also suitable are amides, ethers, urea, substituted ureas such as thiourea, ethylene urea, alkylurea, alkylthiourea, dialkylurea, and dialkylthiourea, carboxylic acids and their salts, such as 2-methylpentanoic acid, 2-ethyl-3-propylacrylic acid, 2-ethyl-hexanoic acid, 3-ethoxyproponic, acid, and the like, esters, organosulfides, organosulfoxides, sulfones (such as sulfolane), carbitol, butyl carbitol, cellusolve, ethers, tripropylene glycol monomethyl ether, ether derivatives, hydroxyethers, amino alcohols, ketones, N-methylpyrrolidinone, 2-pyrrolidinone, cyclohexylpyrrolidone, amides, sulfoxides, lactones, polyelectrolytes, methyl sulfonylethanol, imidazole, 1,3-dimethyl-2-imidazolidinone, betaine, sugars, such as 1-deoxy-D-galactitol, mannitol, inositol, and the like, substituted and unsubstituted formamides, substituted and unsubstituted acetamides, and other water soluble or water miscible materials, as well as mixtures thereof. In embodiments, the co-solvent is selected from the group consisting of ethylene glycol, N-methylpyrrolidone, methoxylated glycerol, ethoxylated glycerol, and mixtures thereof. When mixtures of water and water soluble or miscible organic liquids are selected as the liquid vehicle, the water to organic ratio ranges can be any suitable or desired ration, in embodiments from about 100:0 to about 30:70, or from about 97:3 to about 40:60, or from about 95:5 to about 60:40. The non-water component of the liquid vehicle generally serves as a humectant or co-solvent which has a boiling point higher than that of water (100° C.). The organic component of the ink vehicle can also serve to modify ink surface tension, modify ink viscosity, dissolve or disperse the colorant, and/or affect the drying characteristics of the ink.

In certain embodiments, the co-solvent is selected from the group consisting of sulfolane, methyl ethyl ketone, isopropanol, 2-pyrrolidinone, polyethylene glycol, and mixtures thereof.

The total amount of liquid vehicle can be provided in any suitable or desired amount. In embodiments, the liquid vehicle is present in the curable aqueous latex ink composition in an amount of from about 75 to about 97 percent, or from about 80 to about 95 percent, or from about 85 to about 95 percent, by weight, based on the total weight of the ink.

Colorants

In embodiments, the colorant may include a pigment, a dye, combinations thereof, black, cyan, magenta, yellow, red, green, blue, brown, combinations thereof, in an amount sufficient to impart the desired color to the ink.

The colorant may be provided in the form of a colorant dispersion. In embodiments, the colorant dispersion has an average particle size of from about 20 to about 500 nanometers (nm), or from about 20 to about 400 nm, or from about 30 to about 300 nm. In embodiments, the colorant is selected from the group consisting of dyes, pigments, and combinations thereof, and optionally, the colorant is a dispersion comprising a colorant, an optional surfactant, and an optional dispersant.

As noted, any suitable or desired colorant can be selected in embodiments herein. The colorant can be a dye, a pigment, or a mixture thereof. Examples of suitable dyes include anionic dyes, cationic dyes, nonionic dyes, zwitterionic dyes, and the like. Specific examples of suitable dyes include Food dyes such as Food Black No. 1, Food Black No. 2, Food Red No. 40, Food Blue No. 1, Food Yellow No. 7, and the like, FD & C dyes, Acid Black dyes (No. 1, 7, 9, 24, 26, 48, 52, 58, 60, 61, 63, 92, 107, 109, 118, 119, 131, 140, 155, 156, 172, 194, and the like), Acid Red dyes (No. 1, 8, 32, 35, 37, 52, 57, 92, 115, 119, 154, 249, 254, 256, and the like), Acid Blue dyes (No. 1, 7, 9, 25, 40, 45, 62, 78, 80, 92, 102, 104, 113, 117, 127, 158, 175, 183, 193, 209, and the like), Acid Yellow dyes (No. 3, 7, 17, 19, 23, 25, 29, 38, 42, 49, 59, 61, 72, 73, 114, 128, 151, and the like), Direct Black dyes (No. 4, 14, 17, 22, 27, 38, 51, 112, 117, 154, 168, and the like), Direct Blue dyes (No. 1, 6, 8, 14, 15, 25, 71, 76, 78, 80, 86, 90, 106, 108, 123, 163, 165, 199, 226, and the like), Direct Red dyes (No. 1, 2, 16, 23, 24, 28, 39, 62, 72, 236, and the like), Direct Yellow dyes (No. 4, 11, 12, 27, 28, 33, 34, 39, 50, 58, 86, 100, 106, 107, 118, 127, 132, 142, 157, and the like), Reactive Dyes, such as Reactive Red Dyes (No. 4, 31, 56, 180, and the like), Reactive Black dyes (No. 31 and the like), Reactive Yellow dyes (No. 37 and the like); anthraquinone dyes, monoazo dyes, disazo dyes, phthalocyanine derivatives, including various phthalocyanine sulfonate salts, aza(18)annulenes, formazan copper complexes, triphenodioxazines, and the like; and the like, as well as mixtures thereof.

Examples of suitable pigments include black pigments, white pigments, cyan pigments, magenta pigments, yellow pigments, or the like. Further, pigments can be organic or inorganic particles. Suitable inorganic pigments include carbon black. However, other inorganic pigments may be suitable such as titanium oxide, cobalt blue (CoO—Al₂O₃), chrome yellow (PbCrO₄), and iron oxide. Suitable organic pigments include, for example, azo pigments including diazo pigments and monoazo pigments, polycyclic pigments (e.g., phthalocyanine pigments such as phthalocyanine blues and phthalocyanine greens), perylene pigments, perinone pigments, anthraquinone pigments, quinacridone pigments, dioxazine pigments, thioindigo pigments, isoindolinone pigments, pyranthrone pigments, and quinophthalone pigments), insoluble dye chelates (e.g., basic dye type chelates and acidic dye type chelate), nitro pigments, nitroso pigments, anthanthrone pigments such as PR168, and the like. Representative examples of phthalocyanine blues and greens include copper phthalocyanine blue, copper phthalocyanine green, and derivatives thereof (Pigment Blue 15, Pigment Green 7, and Pigment Green 36). Representative examples of quinacridones include Pigment Orange 48, Pigment Orange 49, Pigment Red 122, Pigment Red 192, Pigment Red 202, Pigment Red 206, Pigment Red 207, Pigment Red 209, Pigment Violet 19, and Pigment Violet 42. Representative examples of anthraquinones include Pigment Red 43, Pigment Red 194, Pigment Red 177, Pigment Red 216 and Pigment Red 226. Representative examples of perylenes include Pigment Red 123, Pigment Red 149, Pigment Red 179, Pigment Red 190, Pigment Red 189 and Pigment Red 224. Representative examples of thioindigoids include Pigment Red 86, Pigment Red 87, Pigment Red 88, Pigment Red 181, Pigment Red 198, Pigment Violet 36, and Pigment Violet 38. Representative examples of heterocyclic yellows include Pigment Yellow 1, Pigment Yellow 3, Pigment Yellow 12, Pigment Yellow 13, Pigment Yellow 14, Pigment Yellow 17, Pigment Yellow 65, Pigment Yellow 73, Pigment Yellow 74, Pigment Yellow 90, Pigment Yellow 110, Pigment Yellow 117, Pigment Yellow 120, Pigment Yellow 128, Pigment Yellow 138, Pigment Yellow 150, Pigment Yellow 151, Pigment Yellow 155, and Pigment Yellow 213. Such pigments are commercially available in either powder or press cake form from a number of sources including, BASF Corporation, Engelhard Corporation, and Sun Chemical Corporation. Examples of black pigments that may be used include carbon pigments. The carbon pigment can be almost any commercially available carbon pigment that provides acceptable optical density and print characteristics. Carbon pigments suitable for use in the present system and method include, without limitation, carbon black, graphite, vitreous carbon, charcoal, and combinations thereof. Such carbon pigments can be manufactured by a variety of known methods, such as a channel method, a contact method, a furnace method, an acetylene method, or a thermal method, and are commercially available from such vendors as Cabot Corporation, Columbian Chemicals Company, Evonik, and E.I. DuPont de Nemours and Company. Suitable carbon black pigments include, without limitation, Cabot pigments such as MONARCH 1400, MONARCH 1300, MONARCH 1100, MONARCH 1000, MONARCH 900, MONARCH 880, MONARCH 800, MONARCH 700, CAB-O-JET 200, CAB-O-JET 300, REGAL, BLACK PEARLS, ELFTEX, MOGUL, and VULCAN pigments; Columbian pigments such as RAVEN 5000, and RAVEN 3500; Evonik pigments such as Color Black FW 200, FW 2, FW 2V, FW 1, FW18, FW S160, FW S170, Special Black 6, Special Black 5, Special Black 4A, Special Black 4, PRINTEX U, PRINTEX 140U, PRINTEX V, and PRINTEX 140V. The above list of pigments includes unmodified pigment particulates, small molecule attached pigment particulates, and polymer-dispersed pigment particulates. Other pigments can also be selected, as well as mixtures thereof. The pigment particle size is desired to be as small as possible to enable a stable colloidal suspension of the particles in the liquid vehicle and to prevent clogging of the ink channels when the ink is used in a thermal ink jet printer or a piezoelectric ink jet printer.

In embodiments, the colorant may be included in the curable aqueous latex ink in an amount of, for example, about 0.1 to about 35%, or from about 1 to about 15%, or from about 3 to about 10% by weight of the curable aqueous latex ink.

Ink Composition Preparation and Use

The ink compositions can be prepared by any suitable process, such as by simple mixing of the ingredients. One process entails mixing all of the ink ingredients together and filtering the mixture to obtain an ink. Inks can be prepared by mixing the ingredients, heating if desired, and filtering, followed by adding any desired additional additives to the mixture and mixing at room temperature with moderate shaking until a homogeneous mixture is obtained, in embodiments from about 5 to about 10 minutes. Alternatively, the optional ink additives can be mixed with the other ink ingredients during the ink preparation process, which takes place according to any desired procedure, such as by mixing all the ingredients, heating if desired, and filtering.

In a specific embodiment, the inks are prepared as follows: 1) preparation of a latex optionally stabilized with a surfactant; 2) preparation of a dispersion of a colorant optionally stabilized with a surfactant; 3) mixing of the latex with the colorant dispersion; 4) optional filtering of the mixture; 5) addition of other components such as water, co-solvents, monomers and/or oligomers, photoinitiators and optional additives; and 6) optional filtering of the composition.

Further examples of ink preparation methods are set forth in the Examples below.

The ink compositions described herein may be jetted at temperatures of less than about 70° C., such as from about 25° C. to about 70° C., or from about 30° C. to about 50° C., or from about 30° C. to about 40° C. The ink compositions are thus ideally suited for use in piezoelectric ink jet devices.

The ink compositions can be employed in indirect (offset) printing ink-jet applications, wherein droplets of the aqueous curable latex ink are ejected in an imagewise pattern onto a recording substrate, the recording substrate is an intermediate-transfer member and the ink in the imagewise pattern is subsequently transferred from the intermediate-transfer member to a final recording substrate.

In a specific embodiment, a process herein comprises incorporating an ink prepared as disclosed herein into an ink jet printing apparatus, ejecting ink droplets in an imagewise pattern onto an intermediate transfer member, heating the image to partially or completely remove solvents, optionally partially curing and transferring the ink in the imagewise pattern from the intermediate transfer member to a final recording substrate, followed by complete curing to form a robust image. In a specific embodiment, the intermediate transfer member is heated to a temperature above that of the final recording sheet and below that of the ink in the printing apparatus. An offset or indirect printing process is also disclosed in, for example, U.S. Pat. No. 5,389,958, the disclosure of which is totally incorporated herein by reference. In one specific embodiment, the printing apparatus employs a piezoelectric printing process wherein droplets of the ink are caused to be ejected in imagewise pattern by oscillations of piezoelectric vibrating elements.

The intermediate-transfer member may take any suitable form, such as a drum or belt.

Once upon the intermediate-transfer member surface, the jetted ink composition may be exposed to radiation to a limited extent (i.e., partially cured) so as to effect a limited curing of the ink upon the intermediate-transfer member surface. This intermediate curing is not to cure the ink composition to its full extent, but merely to assist in setting the jetted ink so that it may be transferred to the image receiving substrate with minimal splitting, which requires the ink droplets to have a certain viscosity before transfer. For controlling the extent of the curing if an intermediate cure is practiced, reference is made to application Ser. Nos. 11/034,850 and 11/005,991, each incorporated herein by reference. This intermediate-curing step is not necessary in embodiments in which the intermediate state is sufficient to impart the desired viscosity to the ink droplets.

Following jetting to the intermediate-transfer member and optional intermediate curing thereon, the ink composition is thereafter transferred to an image receiving substrate. The substrate may be any suitable material such as paper, non-porous flexible food packaging substrates, adhesives for food packaging paper, foil-laminating fabric, plastic, glass, metal, etc. Following transfer to the substrate, the ink composition is then cured by exposing the image on the substrate to radiation. For example, radiation having an appropriate wavelength, mainly the wavelength at which the ink initiator absorbs radiation, may be used. This initiates the curing reaction of the ink composition. The radiation exposure need not be long, and may occur for example, about 0.05 to about 10 seconds, such as from about 0.2 to about 2 seconds. These exposure times are more often expressed as substrate speeds of the ink composition passing under a UV lamp. For example, the microwave energized, doped mercury bulbs available from UV Fusion are placed in an elliptical mirror assembly that is 10 cm wide; multiple units may be placed in series. Thus, a belt speed of 0.1 ms-1 would require 1 second for a point on an image to pass under a single unit, while a belt speed 4.0 ms-1 would require 0.2 seconds to pass under four bulb assemblies. The energy source used to initiate crosslinking of the radiation curable components of the composition can be actinic, for example, radiation having a wavelength in the ultraviolet or visible region of the spectrum, accelerated particles, for example, electron beam radiation, thermal, for example, heat or infrared radiation, or the like. In embodiments, the energy is actinic radiation because such energy provides excellent control over the initiation and rate of crosslinking. Suitable sources of actinic radiation include mercury lamps, xenon lamps, carbon arc lamps, tungsten filament lamps, lasers, light emitting diodes, sunlight, electron beam emitters and the like. The curing light may be filtered, if desired or necessary. The curable components of the ink composition react to from a cured or cross-linked network of appropriate hardness. In embodiments, the curing is substantially complete to complete, i.e., at least 75% of the curable components are cured (reacted and/or cross-linked). This allows the ink composition to be substantially hardened, and thereby to be much more scratch resistant.

Transfer from the intermediate-transfer member to the final recording substrate can be made by any desired or suitable method, such as by passing the final recording substrate through a nip formed by the intermediate-transfer member and a back member, which can be of any desired or effective configuration, such as a drum or roller, a belt or web, a flat surface or platen, or the like. Transfer can be carried out at any desired or effective nip pressure, for example from about 5 pounds per square inch to about 2,000 pounds per square inch, such as from about 10 to about 200 pounds per square inch. The transfer surface may be hard or soft and compliant. Subsequent to transfer, the image on the substrate is cured. The radiation to cure the photo-polymerizable components of the ink composition may be provided by a variety of possible techniques, including but not limited to a xenon lamp, laser light, medium pressure mercury lamps, micro-wave excited mercury lamps often known as a H bulb, doped mercury lamps often referred to as D or V bulbs, LED etc. It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

While the description above refers to particular embodiments, it will be understood that many modifications may be made without departing from the spirit thereof. The accompanying claims are intended to cover such modifications as would fall within the true scope and spirit of embodiments herein.

The presently disclosed embodiments are, therefore, to be considered in all respects as illustrative and not restrictive, the scope of embodiments being indicated by the appended claims rather than the foregoing description. All changes that come within the meaning of and range of equivalency of the claims are intended to be embraced therein.

### EXAMPLES

The examples set forth herein below and are illustrative of different compositions and conditions that can be used in practicing the present embodiments. All proportions are by weight unless otherwise indicated. It will be apparent, however, that the present embodiments can be practiced with many types of compositions and can have many different uses in accordance with the disclosure above and as pointed out hereinafter.

### Comparative Example 1

### Preparation of Latex Containing 1% Dowfax 2A1 Diphenyl Oxide Disulfonate Surfactant

A latex emulsion comprised of polymer particles generated from the emulsion polymerization of styrene, n-butyl acrylate, beta-carboxyethyl acrylate (βCEA) and DOWFAX™ 2A1, an alkyldiphenyloxide disulfonate surfactant from Dow Chemical Company, was prepared as follows.

A surfactant solution of 1.15 grams DOWFAX™ 2A1 and 239.46 grams de-ionized water was prepared by mixing for 10 minutes in a stainless steel holding tank. The holding tank was then purged with nitrogen for 5 minutes before transferring into the reactor. The reactor was then continuously purged with nitrogen while being stirred at 450 rpm. The reactor was then heated up to 80° C. at a controlled rate, and held there. Separately, 4.07 grams of ammonium persulfate initiator was dissolved in 38.19 grams of de-ionized water.

Separately, the monomer emulsion was prepared in the following manner. About 189.90 grams of styrene, 81.38 grams of butyl acrylate, 8.14 grams of beta-CEA, 1.85 grams of 1-dodecanethiol (DDT), 0.95 grams of 1,10-decanediol diacrylate (ADOD) were added to a premix of 4.62 grams of DOWFAX™ 2A1 in 128.28 grams of deionized water were mixed to form an emulsion. 5% of the above emulsion (20.76 grams) was then slowly dropped into the reactor containing the aqueous surfactant phase at 80° C. to form the “seeds” while being purged with nitrogen. The initiator solution was then slowly charged into the reactor. The monomer emulsion was split into two aliquots, 186.81 grams of the monomer emulsion was initially feed into the reactor at 1.51 grams/minute. The second aliquot of 188.81 grams monomer emulsion was mixed with 2.00 grams of DDT and added to the reactor at 2.10 grams/minute. Once all the monomer emulsion was charged into the main reactor, the temperature was held at 80° C. for an additional 3 hours to complete the reaction. Full cooling was then applied and the reactor temperature was reduced to 25° C. The product was collected into a holding tank and sieved with a 25 μm screen.

The particle size was then measured using a Nanotrac® U2275E particle size analyzer and was determined to have a D50 of 133.9 nanometers and a D95 of 201.3 nanometers.

### Example 1

### Preparation of Latex Containing 0.75% Fluorinated Surfactant (Latex A) by Emulsion Polymerization

A latex emulsion comprised of polymer particles generated from the emulsion polymerization of styrene, n-butyl acrylate, beta-CEA and S-764P fluorosurfactant was prepared as follows.

A surfactant solution of 1.4 grams S-764P (anionic fluorosurfactant; ChemGuard) and 237.4 grams de-ionized water was prepared by mixing for 10 minutes in a stainless steel holding tank. The holding tank was then purged with nitrogen for 5 minutes before transferring into the reactor. The reactor was then continuously purged with nitrogen while being stirred at 450 rpm. The reactor was then heated up to 80° C. at a controlled rate, and held there. Separately, 4.1 grams of ammonium persulfate initiator was dissolved in 37.9 grams of de-ionized water.

The monomer emulsion was prepared separately in the following manner. To a premix of 7.9 g of S-764P in 127.2 g of deionized water was added 215 g of styrene, 56 g of n-butyl acrylate, 8.1 g of beta carboxyethyl acrylate (bCEA), 1.8 g of 1-dodecanethiol, and 0.95 g of 1,10-decanediol diacrylate, the resulting mixture was mixed to form an emulsion. About 1% of the above emulsion (4.2 g) was then slowly dropped into the reactor containing the aqueous surfactant phase at 80° C. to form the “seeds” while being purged with nitrogen. The initiator solution was then slowly charged into the reactor. The monomer emulsion was split into two aliquots, 204.3 g of the monomer emulsion was initially feed into the reactor at 1.65 g/min and mixed with 0.71 g of 1-dodecanethiol (a chain transfer agent, which is used to control the molecular weight). The second aliquot of 206.6 g monomer emulsion was mixed with 2.39 g of 1-dodecanethiol and added to the reactor at 2.30 g/min. Once all the monomer emulsion was charged into the main reactor, the temperature was held at 80° C. for an additional 2 hours to complete the reaction. Full cooling was then applied and the reactor temperature was reduced to 25° C. The resultant product was collected into a holding tank and sieved with a 25 μm screen.

The particle size of the latex (Latex VF763) was then measured by Nanotrac® U2275E particle size analyzer to have a D50 of 394 nm.

### Example 2

### Preparation of Latex Containing 1.00% Fluorinated Surfactant (Latex B) by Emulsion Polymerization

Latex B was prepared according to the procedure described in Example 1, except that 1.85 grams of S-764P (anionic fluorosurfactant; ChemGuard) was used in the initial surfactant solution and 10.47 grams of S-764P was used in the monomer emulsion premix. The particle size of the Latex B was measured by Nanotrac® U2275E particle size analyzer to have a D50 of 592.0 nm.

### Example 3

### Preparation of Latex Containing 0.20% Fluorinated Surfactant (Latex C) by Emulsion Polymerization

Latex C was prepared according to the procedure described in Example 1, except that 0.37 grams of S-764P (anionic fluorosurfactant; ChemGuard) was used in the initial surfactant solution and 2.09 grams of S-764P was used in the monomer emulsion premix. The particle size of the Latex C was measured by Nanotrac® U2275E particle size analyzer to have a D50 of 295.0 nm.

Table 1 below summarizes the weight percentage used in the preparartion of Latexes in Examples 1-3.

TABLE 1

| Latex Type | A | B | C |
|---|---|---|---|
| Styrene (%) | 79.3 | 79.3 | 79.3 |
| n-butyl acrylate (%) | 20.7 | 20.7 | 20.7 |
| bCEA | 3.00 | 3.00 | 3.00 |
| 1,10-decanediol diacrylate | 0.35 | 0.35 | 0.35 |
| 1-dodecanethiol (1st addition) | 0.710 | 0.710 | 0.710 |
| 1-dodecanethiol (2nd addition) | 2.390 | 2.390 | 2.390 |
| S-764P fluorosurfactant | 1.00 | 0.75 | 0.20 |
| Ammonium persulfate | 1.50 | 1.50 | 1.50 |
| Dowfax partition | 15/85 | 15/85 | 15/85 |
| Seed % | 1.0 | 1.0 | 1.0 |
| Particle Size D50 (nm) | 592.0 | 394.0 | 295.0 |

### Example 4

### Properties of Latexes

1. Foaming Measurements

In this example, Latex A prepared from Example 1 and several Control Latexes were evaluated for foam height.

About 5 g of latex sample was transferred to a 40 mL vial with 25 mm outside base diameter and 98 mm height. The vial was placed on a Rose Scientific Ltd K-MS2 Vortex at 3000 rpm setting for 10 sec. The height of the foam produced using the bottom of vial as reference was measured two times (Run 1 and Run 2) and the average was recorded in Table 2 below.

TABLE 2

| | Foam Height (cm) | | |
|---|---|---|---|
| Latex | Run 1 | Run 2 | Avg. |
| Control Latex 1: (polyester) | 2.20 | 2.10 | 2.15 |
| Control Latex 2: (sulfonated polyester) | 1.50 | 1.40 | 1.45 |
| Control Latex 3: (Styrene-nButyl Acrylate | 2.00 | 1.90 | 1.95 |
| with 1% Dowfax 2A1) | | | |
| Example 1: Latex A (Styrene-nButyl Acrylate | 1.30 | 1.40 | 1.35 |
| with 0.75% fluorosurfactant) | | | |

The foaming measurements show that latex synthesized with a fluorosurfactant of the present embodiments (e.g., Latex A) produces significant less foam than the control latexes including BSPE-1, which is a self-stabilizing sulfonated polyester which requires no (i.e., 0%) surfactant during emulsification.

2. Surface Tension Measurements

In this example, Latex A prepared from Example 1 and several Control Latexes were evaluated for surface tension.

Surface Tension was measured at room temperature using Kruss K-100 Tensiometer using the using a Wilhelmy plate technique.

The surface tensions of the latex samples are recorded in Table 3 below:

TABLE 3

| | | Avg. | Std. Dev. |
|---|---|---|---|
| | Surface | Surface | Surface |
| | Tension | Tension | Tension |
| Latex | [mN/m] | [mN/m] | [mN/m] |
| Control Latex 4: (St-nBA pilot plant | 48.01 | 47.98 | 0.05 |
| latex with 1% Dowfax 2A1) | | | |
| Control Latex 3: (St-nBA lab latex with | 50.43 | 50.39 | 0.08 |
| 1% Dowfax 2A1) | | | |
| Example 1: Latex A (Styrene-nButyl | 18.33 | 18.32 | 0.02 |
| Acrylate with 0.75% fluorosurfactant) | | | |

### Example 5

### Prophetic Ink Formulation

To a 50 mL amber glass vial was added water and pH adjusted latex (pH=6.8) which was stirred for 2 minutes at 300 RPM. To the stirring mixture was added carbon black dispersion and stirred for an additional 2 minutes at 300 RPM. To the pre-ink was added the co-solvents sulfolane and 1,5-pentanediol and the mixture was further stirred for an additional 1 minute or more at 500 RPM. The surfactants FS8050 and A008 were added to the ink and the mixture was stirred for 45 minutes at 500 RPM. The ink was then homogenized for 5 minutes at 2000 RPM and filtered through a 0.45 micron filter before testing. Table 4 below shows the components of Control Ink A.

TABLE 4

| Component | solids wt % | solids | wt % | m/g |
|---|---|---|---|---|
| Control Latex 3 | 10.00% | 47.10% | 21.23% | 6.3694268 |
| Sulfolane (5% water) | 15.00% | 95.00% | 15.79% | 4.7368421 |
| 1,5-Pentanediol | 20.00% | 100.00% | 20.00% | 6 |
| Carbon Black 300 | 3.30% | 14.87% | 22.19% | 6.6577001 |
| FS8050 | 1.12% | 100% | 1.12% | 0.336 |
| A008 | 0.50% | 100% | 0.50% | 0.15 |
| Water | 50.08% | 100.00% | 19.17% | 5.7500311 |
| TOTAL | | | 100.0% | 30.00 |

Table 5 below shows the components of Experimental Ink B.

TABLE 5

| Component | solids wt % | solids | wt % | m/g |
|---|---|---|---|---|
| Latex A | 10.00% | 47.10% | 21.23% | 6.3694268 |
| Sulfolane (5% water) | 15.00% | 95.00% | 15.79% | 4.7368421 |
| 1,5-Pentanediol | 20.00% | 100.00% | 20.00% | 6 |
| Carbon Black 300 | 3.30% | 14.87% | 22.19% | 6.6577001 |
| FS8050 | 1.12% | 100% | 1.12% | 0.336 |
| A008 | 0.50% | 100% | 0.50% | 0.15 |
| Water | 50.08% | 100.00% | 19.17% | 5.7500311 |
| TOTAL | | | 100.0% | 30.00 |

### Example 6

### Ink Characterization

Both Ink A (control) and Ink B (containing fluorosurfactant of the present embodiments) were formulated without defoamer. Surface tension and foam height of the latexes were measured according to the procedures described in Example 4, and the results are shown in Table 6 below.

Ink B has significantly less foaming. For comparison purpose, typically, an ink with defoamer produces between about 1.0 and about 1.1 cm foam in height after shaking/vortexing.

Ink foaming was assessed using the following ASTM procedure:

About 5 g of sample was transferred to 40 mL vial (Fisher Scientific, Part number: 03-339-14A-EPA VIAL CLR outside base diameter 25 mm, height is 98 mm). The vial was vortexed using Rose Scientific Ltd K-MS2 Vortex on highest setting for 10 sec at 3000 rpm. The foam height of the foam produced was measured using the bottom of vial as reference. The approximate height of 5 g ink was about 1 cm (which represents no foam).

TABLE 6

| | | Surface | |
|---|---|---|---|
| | | tension | Foam |
| Ink | Latex | mN/m | (cm) |
| Ink A | Control Latex 3 (St-nBA lab latex | 24.0 | 1.8 |
| | with 1% Dowfax 2A1) | | |
| Ink B | Latex A (St-nBA | 22.0 | 1.3 |
| | with 0.75% fluorosurfactant) | | |

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others. Unless specifically recited in a claim, steps or components of claims should not be implied or imported from the specification or any other claims as to any particular order, number, position, size, shape, angle, color, or material.

All the patents and applications referred to herein are hereby specifically, and totally incorporated herein by reference in their entirety in the instant specification.

What is claimed is:

1. An ink for use in an indirect printing process comprising:
water;
a co-solvent; and
a fluorosurfactant-stabilized polymer latex comprising a polystyrene copolymer latex having a glass transition temperature of from 55° C. to about 63° C., and a fluorosurfactant, wherein the fluorosurfactant is an anionic phosphate ester and does not covalently bind to the polymer latex, wherein the fluorosurfactant comprises a partially or fully fluorinated alkyl group having from 1 to 12 carbon atoms and a perfluoro telomer, and further wherein the fluorosurfactant is present in the ink in an amount from about 0.0001 percent to about 0.1 percent by weight based on the total weight of the ink.

2. The ink of claim 1, wherein the fluorosurfactant is present in the ink in an amount from about 0.0375 percent to about 0.05 percent by weight based on the total weight of the ink.

3. The ink of claim 2, wherein the fluorosurfactant is present in the ink in an amount from about 0.001 percent to about 0.075 percent by weight based on the total weight of the ink.

4. The ink of claim 1 further comprising a second surfactant.

5. The ink of claim 1, wherein the co-solvent has a solubility parameter in the range of from about 27 to about 37 MPa^{1/2}.

6. The ink of claim 1, wherein the co-solvent is selected from the group consisting of 1,5-pentanediol, 2-pyrollidone, glycerol, and mixtures thereof.

7. The ink of claim 1, wherein the polystyrene copolymer latex comprises a latex emulsion comprising polymer particles generated from the emulsion polymerization of styrene and a monomer selected from the group consisting of n-butyl acrylate, methacrylic acid, β-carboxyethyl acrylate or mixtures thereof.

8. The ink of claim 1, wherein the polystyrene copolymer latex is present in an amount of about 3 to about 20 weight percent based on the total weight of the ink.

9. The ink of claim 1, wherein the polystyrene copolymer has a weight average molecular weight of from about 10,000 g/mol to about 40,000 g/mol.

10. The ink of claim 1, wherein the polystyrene copolymer has a volume average particle size of from about 50 nm to about 300 nm.

11. The ink of claim 1 further comprising a colorant selected from the group consisting of pigment, dye, mixtures of pigment and dye, mixtures of pigments, and mixtures of dyes.

12. The ink of claim 1 having a surface tension of from about 18 to about 35 mN/m at a jetting temperature of less that about 70° C.

13. The ink of claim 1 having a viscosity of from about 2 centipoise to about 20 centipoise 30° C.

14. A low foaming ink for use in an indirect printing process comprising:
water;
a co-solvent; and
a fluorosurfactant-stabilized polymer latex comprising a polystyrene copolymer latex having a glass transition temperature of from 55° C. to about 63° C. and an anionic phosphate ester fluorosurfactant, wherein the fluorosurfactant does not covalently bind to the polymer latex, wherein the fluorosurfactant comprises a partially or fully fluorinated alkyl group having from 1 to 12 carbon atoms and a perfluoro telomer, and further wherein the fluorosurfactant is present in the ink in an amount from about 0.0001 percent to about 0.1 percent by weight based on the total weight of the ink; and
further wherein the ink has a surface tension of from about 18 to about 35 mN/m a jetting temperature of less that about 70° C.

15. The ink of claim 14, wherein the polystyrene copolymer latex comprises a latex emulsion comprising polymer particles generated from the emulsion polymerization of styrene and a monomer selected from the group consisting of n-butyl acrylate, methacrylic acid, β-carboxyethyl acrylate and mixtures thereof.

16. An ink for use in an indirect printing process comprising:
water;
a co-solvent; and
a fluorosurfactant-stabilized polymer latex comprising a polystyrene copolymer latex having a glass transition temperature of from 55° C. to about 63° C., and a fluorosurfactant, wherein the fluorosurfactant is an ammonia neutralized phosphate ester type or a diethanolamine neutralized phosphate ester type and does not covalently bind to the polymer latex, wherein the fluorosurfactant comprises a partially or fully fluorinated alkyl group having from 1 to 12 carbon atoms and a perfluoro telomer, and further wherein the fluorosurfactant is present in the ink in an amount from about 0.0001 percent to about 0.1 percent by weight based on the total weight of the ink.

17. The ink of claim 16, wherein the fluorosurfactant is present in the ink in an amount from about 0.001 percent to about 0.075 percent by weight based on the total weight of the ink.

18. The ink of claim 17, wherein the fluorosurfactant is present in the ink in an amount from about 0.0375 percent to about 0.05 percent by weight based on the total weight of the ink.

19. The ink of claim 16 further comprising a second surfactant.

20. The ink of claim 19, wherein the second surfactant is selected from the group consisting of ionic surfactants, anionic surfactants, cationic surfactants, nonionic surfactants, zwitterionic surfactants, and mixtures thereof.
